(19) United States
(12) Patent Application Publication
(10) Pub. No.: US 2007/0264933 A1
(43) Pub. Date: Nov. 15, 2007

(54) Apparatus and method for changing relay station in data delivery route in broadband wireless access communication system

(75) Inventors: Hyun-Jeong Kang, Seoul (KR); Jae-Weon Cho, Suwon-si (KR); Sung-Jin Lee, Seoul (KR); Young-Bin Chang, Anyang-si (KR); Mi-Hyun Lee, Seoul (KR); Soon-Mi Cho, Seoul (KR); Hyoung-Kyu Lim, Seoul (KR); Yeong-Moon Son, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Gyeonggi-do (KR)

(21) Appl. No.: 11/803,436

(22) Filed: May 15, 2007

(30) Foreign Application Priority Data
May 15, 2006 (KR) 2006-0043254
Feb. 14, 2007 (KR) 2007-0015468

(51) Int. Cl. H04B 7/185

(52) U.S. Cl. 455/13.1

(57) ABSTRACT

An apparatus and method for changing a data delivery route in a multi-hop relay Broadband Wireless Access (BWA) communication system are provided, in which a Relay Station (RS) scans neighboring nodes and an upper node. The RS transmits a scanning result report message to a base station (BS), and connects to a new upper node, upon receipt of a node change request message requesting the RS to change from the upper node to the new upper node from the BS.

### PRIORITY

This application claims priority under 35 U.S.C. § 119 to an application filed in the Korean Intellectual Property Office on May 15, 2006 and assigned Serial No. 2006-0043254, and an application filed in the Korean Intellectual Property Office on Feb. 14, 2007 and assigned Serial No. 2007-0015468, the contents of which are incorporated herein by reference.

### BACKGROUND OF THE INVENTION

1. Field of the Invention

The present invention relates generally to a multi-hop relay Broadband Wireless Access (BWA) communication system, and in particular, to an apparatus and method for modifying a data delivery route by changing a path between Relay Stations (RSs), i.e. an RS-RS path in a three or more-hop relay system designed to expand the cell area of a serving cell.

2. Description of the Related Art

Provisioning of services with diverse Quality of Service (QoS) requirements at or above 100 Mbps to users is an active study area for a future-generation communication system called a 4^{th} Generation (4G) communication system. Particularly, active research on provisioning of high-speed service by ensuring mobility and QoS to a BWA communication system such as Wireless Local Area Network (WLAN) and Wireless Metropolitan Area Network (WMAN) is on-going. Major examples are Institute of Electrical and Electronics Engineers (IEEE) 802.16d and IEEE 802.16e.

The IEEE 802.16d and IEEE 802.16e communication systems are implemented by applying Orthogonal Frequency Division Multiplexing (OFDM)/Orthogonal Frequency Division Multiple Access (OFDMA) to physical channels. IEEE 802.16d considers only a single-cell structure with no regard to mobility of SSs. In contrast, IEEE 802.16e supports the SSs' mobility. Herein below, a mobile SS is referred to as an MS.

FIG. 1 illustrates the configuration of a conventional IEEE 802.16e communication system.

In FIG. 1, the IEEE 802.16e communication system is configured in a multi-cell structure. Specifically, it is comprised of cells 100 and 150, BSs 110 and 140 for managing cells 100 and 150, respectively, and a plurality of MSs 111, 113, 130, 151 and 153. Signaling is carried out in OFDM/OFDMA between BSs 110 and 140 and MSs 111, 113, 130, 151 and 153. MS 130 exists in a cell boundary area between cells 100 and 150, i.e. in a handover region. When MS 130 moves to cell 150 managed by BS 140 during signal transmission/reception to/from BS 110, the serving BS of MS 130 changes from BS 110 to BS 140.

Since signaling is performed between an MS and a fixed BS via a direct link as illustrated in FIG. 1, a highly reliable radio communication link can be established between them in conventional IEEE 802.16e communication system. However, due to the fixedness of BSs, a wireless network cannot be configured with flexibility. As a result, the IEEE 802.16e communication system is not effective in efficiently providing communication services in a radio environment experiencing a fluctuating traffic distribution and great change in the number of required calls.

Applying a multi-hop relay data transmission scheme using fixed RSs, mobile RSs, or general MSs to general cellular wireless communication systems such as IEEE 802.16e can solve the above problem. The multi-hop relay wireless communication system can advantageously reconfigure a network rapidly according to a communication environmental change and enables efficient operation of the whole wireless network. For example, it can expand cell coverage and increase system capacity. When the channel status between a BS and an MS is bad, an RS can be installed between them so that the resulting establishment of a multi-hop relay path through the RS renders a higher-speed radio channel available to the MS. With the use of the multi-hop relay scheme at a cell boundary offering a bad channel status, high-speed data channels can be provided and the cell coverage can be expanded.

FIG. 2 illustrates the configuration of a multi-hop relay BWA communication system configured to expand the cell coverage of BSs.

Referring to FIG. 2, the multi-hop relay BWA communication system, which is configured in a multi-cell structure, includes cells 200 and 240, BSs 210 and 250 for managing cells 200 and 240, respectively, a plurality of MSs 211 and 213 within the coverage area of cell 200, a plurality of MSs 221 and 223 managed by BS 210 but located in an area 230 outside cell 200, an RS 220 for providing multi-hop relay paths between BS 210 and MSs 221 and 223 within area 230, a plurality of MSs 251, 253 and 255 within the coverage area of cell 240, a plurality of MSs 261 and 263 managed by the BS 250 but located in an area 270 outside cell 240, and an RS 260 for providing multi-hop relay paths between BS 250 and MSs 261 and 263 within area 270. OFDM/PFDMA signals are exchanged among BSs 210 and 250, RSs 220 and 260, and MSs 211, 213, 221, 223, 251, 253, 255, 261 and 263.

Although MSs 211 and 213 within the coverage area of cell 200 and RS 220 can communicate directly with BS 210, MSs 221 and 223 within area 230 cannot communicate with BS 210, directly. Therefore, RS 220 covering area 230 relays signals between BS 210 and MSs 211 and 223. Meanwhile, although MSs 251, 253 and 255 within the coverage area of cell 240, and RS 260 can communicate directly with BS 250, MSs 261 and 263 within the area 270 cannot communicate with BS 250, directly. Therefore, RS 260 covering area 270 relays signals between BS 250 and MSs 261 and 263, and MSs 261 and 263 can exchange signals with BS 250 via RS 260.

In the multi-hop relay BWA communication systems illustrated in FIG. 2, RSs 220 and 260 are infrastructure RSs installed by service providers and thus known to BSs 210, 240 and 310, or client RSs acting as SSs or MSs, or as RSs under circumstances. RSs 220 and 260 may also be fixed, nomadic (e.g. laptop), or mobile like MSs.

For expanding the cell area of a BS through RSs, a scenario can be envisaged in which the BS sends data to an MS via two or more RSs supporting the cell coverage expansion. In accordance with the present invention, a method for modifying the data delivery route among the RSs is provided when a data delivery route is defined by a plurality of RSs that relay data between a BS and an MS in the above three or more-hop relay system.

FIG. 3 illustrates a scenario in which a data delivery route is modified by changing an RS-RS path in a multi-hop relay BWA communication system.

Referring to FIG. 3, the multi-hop relay BWA communication system includes cells 310 to 340, a BS 311 for managing cell 310, an RS 321 managed by BS 311 but located in an area 320 outside cell 310, for providing a relay path between BS 311 and an MS 333, an RS 341 managed by BS 311 but located in an area 340 outside cell 310, for providing a relay path between BS 311 and MS 333, MS 333 managed by BS 311 but located in an area 330 outside cell 310, and an RS 331 in cell 330, for providing a relay path between MS 333 and RS 311.

If data is exchanged between BS 311 and MS 333 via RS 341 and RS 331, a data delivery route between BS 311 and MS 333 is path 1 denoted by arrows 351, 353 and 355. When the system of RS 341 is down or the link status between BS 311 and RS 341 becomes poor, the data delivery route needs to be changed from path 1 to another path.

On the assumption that RS 321 is selected to relay data to/from MS 333, path 2 denoted by arrows 361, 363 and 355 is defined as a new data delivery route. Thus, data can be delivered between BS 311 and MS 333 in path 2.

Accordingly, there exists a need for developing a method when a data delivery route needs to be modified by changing from one RS-RS path to another RS-RS path. The method would need to notify an RS responsible for changing the RS-RS path of the path change and define a new data delivery route in a relay system in which data is delivered in a route running through a plurality of RSs as in the scenario illustrated in FIG. 3.

### SUMMARY OF THE INVENTION

An aspect of the present invention is to substantially solve at least the above problems and/or disadvantages and to provide at least the advantages below. Accordingly, the present invention provides an apparatus and method for modifying a data delivery route by changing from one RS-RS path to another RS-RS path in a multi-hop relay BWA communication system.

Another aspect of the present invention is to provide an apparatus and method for reporting channel measurements about neighboring RSs to a BS by an RS residing in a data delivery route to an MS, and instructing the RS to change the data delivery route by the BS when the BS determines that the data delivery route needs to be modified in a multi-hop relay BWA communication system.

According to one aspect of the present invention, there is provided a method for changing the data delivery route to an RS in a multi-hop relay BWA communication system, in which the RS scans a neighboring node and an upper node and transmits a scanning result report message to a BS, and connects to a new upper node, upon receipt of a node change request message requesting the RS to change from the upper node to the new upper node from the BS.

According to another aspect of the present invention, there is provided a method for changing a data delivery route to a BS in a multi-hop relay BWA communication system, in which the BS determines whether a data delivery route needs to be changed, upon receipt of a scanning result report message reporting scanning results of a neighboring node and an upper node of an RS from the BS, determines an upper node for the RS, to form a new data delivery route, and transmits to the RS a node change request message requesting the RS to change from the previous upper node to the new upper node.

According to a further aspect of the present invention, there is provided an apparatus for changing the path between RSs in a multi-hop relay BWA communication system, in which an RS scans a neighboring node and an upper node, transmits a scanning result report message to a BS, and the BS determines if a data delivery route needs to be changed, upon receipt of the scanning result report message from the RS, determines the new upper node for the RS, to form a new data delivery route, when determining that the data delivery route needs to be changed, and transmits the node change request message to the RS, which connects to a new upper node, upon receipt of a node change request message requesting the RS to change from the previous upper node to the new upper node from the BS.

According to still another aspect of the present invention, there is provided a method for changing a data delivery route to a BS in a multi-hop relay BWA communication system, in which the BS determines whether the data delivery route needs to be changed, if a channel status of an RS is equal to or less than a predetermined threshold, requests a lower RS of the RS to scan neighboring nodes and report scanning results to the BS, upon receipt of the scanning results from the lower RS determines a new upper node for the lower RS for configuring a new data delivery route , and requests the lower RS to change from the RS to the new upper node.

According to yet another aspect of the present invention, there is provided an apparatus for changing the path between RSs in a multi-hop relay BWA communication system, in which a BS determines that a data delivery route needs to be changed, if a channel status of an RS is equal to or less than a predetermined threshold. The BS transmits a scanning request message to a lower RS of the RS, the scanning request message requesting the lower RS to scan neighboring nodes and report scanning results to the BS, upon receipt of the scanning results from the lower RS, the BS determines a new upper node for the lower RS, for configuring a new data delivery route, and transmits to the lower RS a node change request message requesting the lower RS to change from the RS to the new upper node, and the lower RS scans the neighboring nodes, upon receipt of the scanning request message from the BS, and connects to the new upper node, upon receipt of the node change request message from the BS.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the configuration of a conventional IEEE 802.16e communication system;

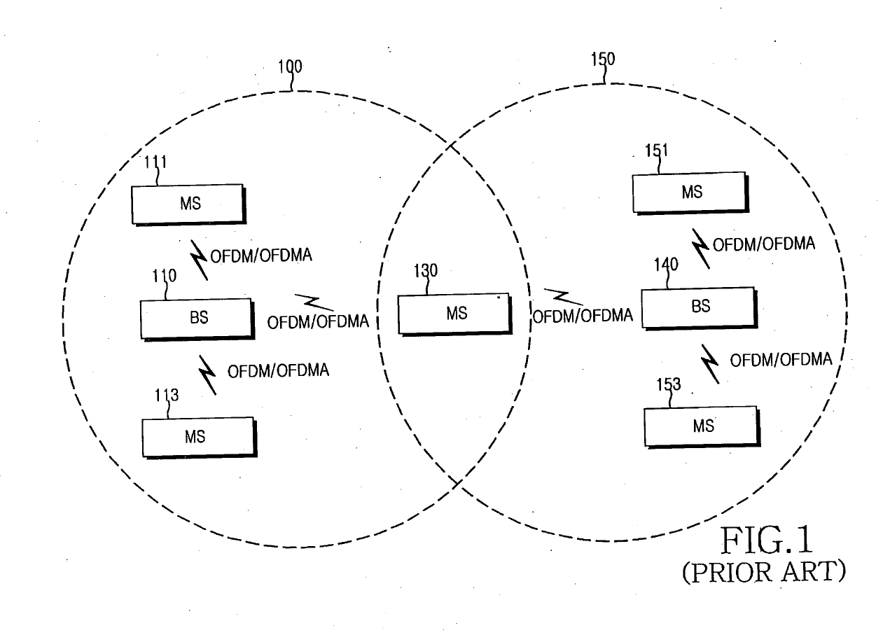

FIG. 2 illustrates the configuration of a multi-hop relay BWA communication system configured to expand the cell coverage of BSs;

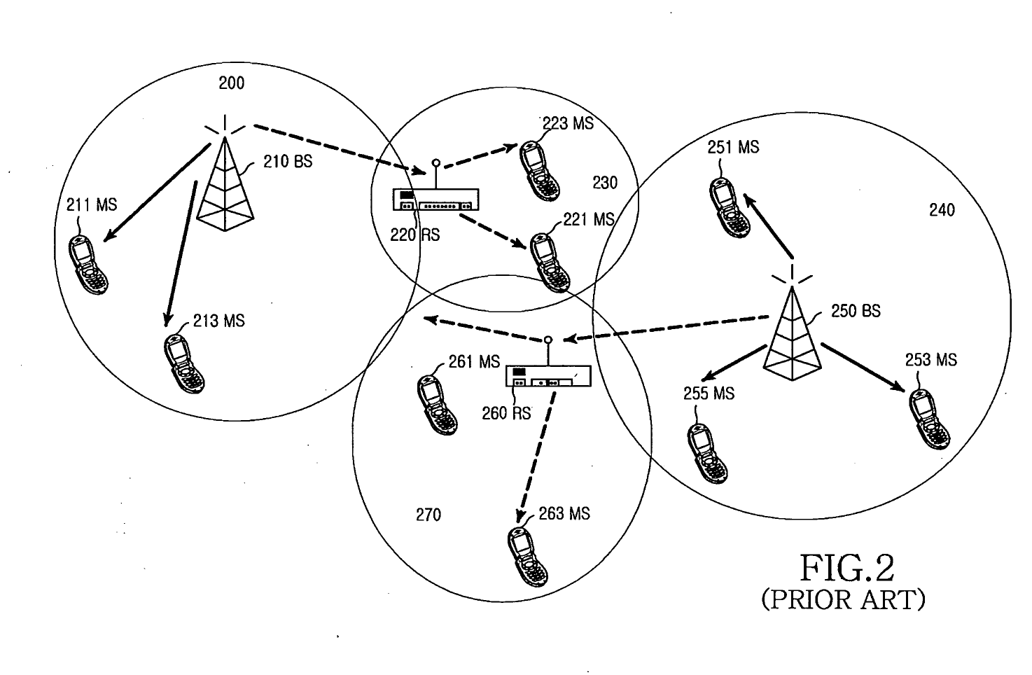

FIG. 3 illustrates a scenario in which a data delivery route is modified by changing an RS-RS path in a multi-hop relay BWA communication system;

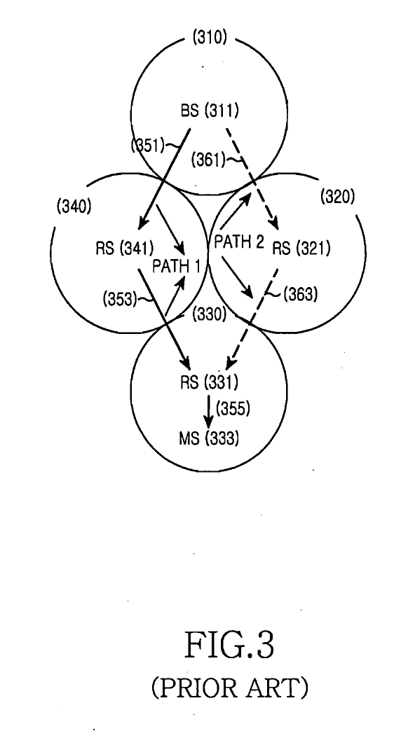

FIG. 4 is a flowchart of an operation of an RS for receiving a route change request in a multi-hop relay BWA communication system according to the present invention;

FIG. 5 is a flowchart of an operation of a BS for commanding the RS to change its upper node in a data delivery route in a multi-hop relay BWA communication system according to the present invention; and

FIG. 6 is a block diagram of the BS (or the RS) according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention discloses an apparatus and method for modifying a data delivery route by changing an RS-RS path in a three or more-hop relay BWA communication system.

The multi-hop relay BWA communication system operates in OFDM/OFDMA. Because OFDM/OFDMA sends physical channel signals on a plurality of subcarriers, the multi-hop relay BWA communication system is capable of high-speed data transmission that supports the mobility of MSs in a multi-cell configuration. While the present invention is described in the context of the BWA communication system, it is a mere exemplary application. Therefore, the present invention is also applicable to any cellular communication system using a multi-hop relay scheme.

In the multi-hop relay BWA communication system, RSs may be fixed or mobile nodes, or particular systems installed by BSs. Such a node serves as an RS through relay capability negotiations with a BS according to a preset criterion for cell coverage expansion.

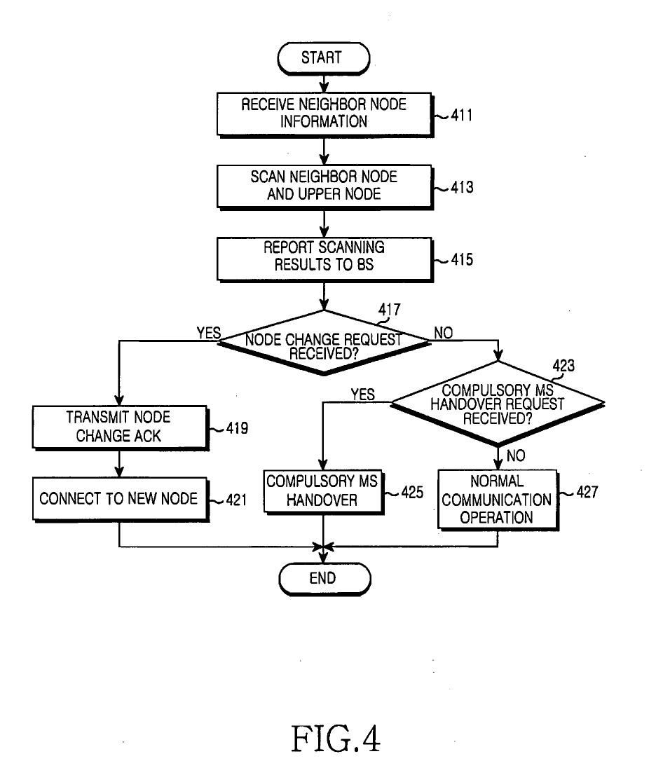

Referring to FIG. 4, the RS receives neighboring node information from a BS in step 411. The neighboring node information can be acquired through a Neighbor notification message including information about the BS, RSs managed by the BS, neighboring BSs, and RSs managed by the neighboring BSs. Besides the purpose of providing information about BSs and RSs to an RS that resides in a data delivery route, the Neighbor notification message serves the purpose of providing neighboring node information to a mobile RS, for use in selecting a target node for handover. The Neighbor notification message is configured as shown in Table 1 below.

TABLE 1

| Syntax | Notes |
|---|---|
| Neighbor Notification Message | |
| format( ) { | |
| N_BSs | Number of neighbor BSs |
| For (i=0; i<N_BSs; i++) { | |
| BS ID | BS identifier |
| Support mode | Indicates which mode the BS supports |
| | (BS mode & frame structure) |
| | 0: 16e only |
| | 1: 16e & MMR |
| | 2: MMR only |
| | 3–7: reserved for the type of frame |
| | structure which is supported by the BS |
| } | |
| N_RSs | Number of neighboring RSs |
| For (i=0; i<N_RSs; i++) { | |
| RS ID | RS identifier |
| } | |
| } | |

In Table 1, the Neighbor notification message has N_BSs indicating the number of BSs included in the message, BS ID identifying each of the BSs, and Support mode indicating the mode supported by each of the BSs. Support mode indicates whether a BS supports a conventional IEEE 802.16 system only, both the conventional IEEE 802.16 system and an IEEE 802.16 relay system, or the IEEE 802.16 relay system only. It may also include information about a frame structure supported by the BS. As Support mode tells a mobile RS a mode supported by a target BS to which the mobile RS will perform a handover, if the target BS supports only the conventional IEEE 802.16 system, the mobile RS is aware that it cannot provide a relay service. To continue with an on-going communication service to a lower node, the mobile RS may perform a separate operation for providing the communication service. In addition to the above neighboring BS information, the Neighbor notification message includes N_RSs indicating the number of RSs included in the message and RS ID identifying each of the RSs.

The Neighbor notification message can be unicasted to a particular RS or broadcasted to all RSs. Because the Neighbor notification message provides a brief overview of neighboring BSs and RSs, the RS may acquire details about the neighboring BSs or the neighboring RSs from a conventional Neighbor Advertisement (MOB_NBR-ADV) message. Alternatively, the RS may acquire information about the neighboring RSs from an MR_NBR-INFO message that the BS sends so that the RS can create a MOB_NBR-ADV message directed to a lower MS. The MR_NBR-INFO message may contain preamble indexes, midamble indexes or postamble indexes of the neighboring RSs, for use in scanning the neighboring RSs by the RS. The MR_NBR-INFO message may also include system configuration information related to the frame structures of the neighboring nodes.

In step 413, the RS scans the neighboring BSs or the neighboring RSs, and an upper node of the RS indicated by the Neighbor notification message or the MR_NBR-INFO message. The scanning is initiated by requesting from the serving BS for the RS or autonomously by the RS. The BS-initiated scanning may occur when an upper RS can no longer provide a data delivery route to the MS due to a system problem. As with the BS-initiated scanning, the autonomous scanning is performed through negotiations with the BS or without negotiations. The RS can autonomously initiate scanning when the channel status between the RS and its upper node is below a scanning level threshold suitable for providing a data delivery path to the MS. The scanning level threshold can be indicated by a control message sent by the serving BS. The control message has the following configuration illustrated in Table 2 below.

TABLE 2

| | Length | |
|---|---|---|
| Name | (bits) | Value |
| scanning level threshold | 8 | The signal level threshold between |
| | | RS and upper node to scan other |
| | | nodes |

In Table 2, scanning level threshold indicates a scanning level threshold between the RS and its upper node by which the RS forming the data delivery route to the MS can decide as to whether to perform scanning. The scanning level threshold can be Carrier-to-Interference and Noise Ratio (CINR).

In step 415, the RS sends an RS signal quality report message to the BS, thus reporting scanning results of the neighboring nodes and the upper node. The RS signal quality report message includes the information described in Table 3 below.

TABLE 3

| Syntax | Notes |
|---|---|
| RS signal quality report message | |
| format( ) { | |
| N_Nodes | Number of nodes (BS or RS) which are |
| | reported |
| For (i=0; i<N_Nodes; i++) { | |
| Node ID | Node's identifier |
| Signal level | Signal measurement result (i.e. CINR |
| | mean) |
| } | |
| } | |

In Table 3, the RS signal quality report message includes N_Nodes indicating the number of nodes reported to the BS, Node ID identifying each of the nodes, and Signal level that provides channel measurements of the nodes.

The RS signal quality report message contains information about only nodes having signal levels greater than or equal to a ‘report level threshold’. The report level threshold, by which the nodes to be included in the RS signal quality report message are selected, is included in a control message that the BS sends to the RS. The report level threshold is shown in Table 4.

TABLE 4

| | Length | |
|---|---|---|
| Name | (bits) | Value |
| Report level threshold | 8 | The node's signal level threshold to |
| | | be reported by RS |

In Table 4, report level threshold indicates a report level threshold for a node to be reported by the RS. The report level threshold can be CINR.

In step 417, the RS monitors reception of a Route change request message commanding the RS to change its upper node. The Route change request message includes the following information shown in Table 5 below.

TABLE 5

| Syntax | Notes |
|---|---|
| Route change request message format( ) | |
| { | |
| Type | Indicate the type |
| | 0: route change request |
| | 1: MS compulsory handover |
| | request |
| RS ID | Requestee's ID |
| New upper node ID | New upper node ID |
| } | |

In Table 5, the Route change request message contains Type specifying the purpose of sending the message, RS ID identifying an RS for receiving the message and changing its upper node, and New upper node ID identifying the upper node of the RS. Type is set to ‘route change request’ commanding the RS to change the upper node in the data delivery route, or ‘MS compulsory handover request’ requesting that the MS should be compulsorily handed over to the service area of another BS because a communication service cannot be provided to an MS managed by the RS in the service area of the BS. The Route change request message may further include system configuration information about, for example, a frame structure required for the RS to continue relaying signals to a lower node managed by the RS after changing the upper node. The BS can also provide the RS with a frame number corresponding to the time of network reentry to a new upper node and information about a relay zone in which the new upper node sends a DownLink (DL)-MAP. Further, the Route change request message may include information necessary for the network reentry of the new upper node and information about an Uplink (UL) area in which the RS will send a non-contention-based ranging message to the new upper node.

Upon receipt of the Route change request message commanding an upper node change from the BS, i.e. the Route change request message with Type set to ‘route change request’ in step 417, the RS replies with a Route change ‘ack’ message having the configuration illustrated in Table 6.

TABLE 6

| Syntax | Notes |
|---|---|
| Route change ACK message format( ) { | |
| RS ID | Requestee's ID |
| New upper node ID | New upper node ID allocated by |
| | RS |
| } | |

In Table 6, the Route change ‘ACK’ message includes RS ID identifying the RS that has received the Route change request set to ‘route change request’ and New upper node ID identifying the new upper node. The Route change ‘ACK’ message may further include information about MS data transmission that the RS has processed so far.

The RS is connected to the new upper node in step 421 and then ends the algorithm of the present invention.

In the mean time, if the RS has not received the Route change request message commanding the RS to change the upper node in step 417, it monitors reception of a Route change request message commanding an MS compulsory handover in step 423. Upon receipt of the Route change request message commanding an MS compulsory handover, i.e. the Route change request message with Type set to ‘MS compulsory handover request’, the RS commands the MS to perform a compulsory handover and performs a compulsory handover procedure for the MS in step 425 and then ends the process.

Alternatively, the RS is aware that the MS has performed a handover to another RS or another BS by receiving a message notifying the handover of the MS and commanding deletion of information about the MS.

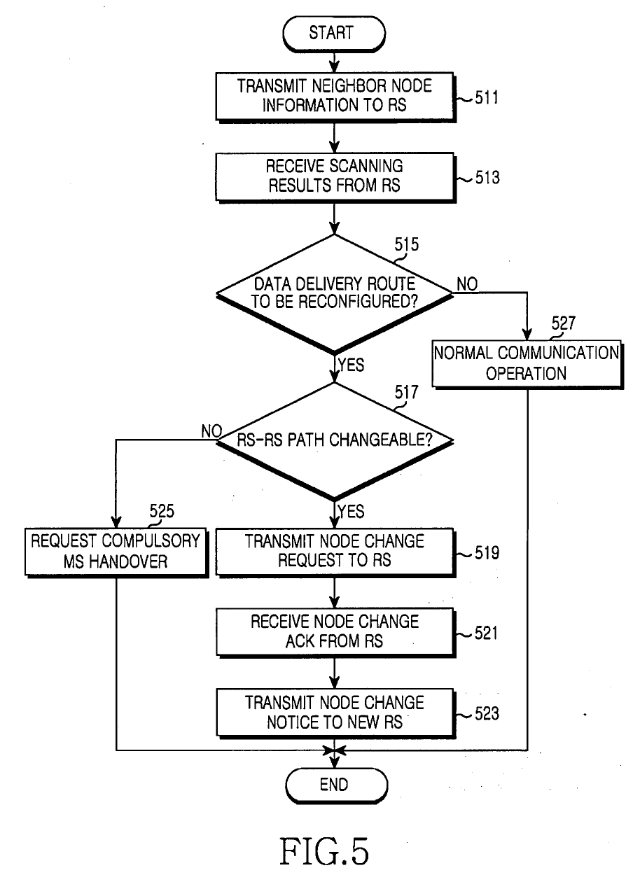

Referring to FIG. 5, the BS provides neighboring node information to an RS managed by the BS by a Neighbor notification message configured as illustrated in Table 1 or an MR_NBR-INFO message in step 511. In step 513, the BS receives an RS signal quality report message having the configuration illustrated in Table 3, reporting scanning results of neighboring nodes from the RS. The scanning is initiated by the BS or autonomously by the RS. In the former case, the BS may command the neighboring nodes to send their preambles, midambles, or postambles and provide the indexes of the preamble, midambles or postambles to the RS so that the RS can scan them.

In step 515, the BS determines whether to reconfigure a data delivery route to an MS. In determining to reconfigure the data delivery route, the BS determines if it is possible to reconfigure the data delivery route by changing a path between RSs under its control in step 517.

When the BS determines that changing the RS-RS path can reconfigure the data delivery route, in step 519 it commands the RS to change its upper node by a Route change request configured as illustrated in Table 5. The Route change request message includes information about a new upper node to be added for reconfiguring the data delivery route. In step 521, in response to the Route change request message, the BS confirms that the RS will change the upper node by receiving a Route change ack message having the configuration illustrated in Table 6. The BS sends a Route change notice message to the new upper node, i.e. a new RS, thus notifying the RS's connection to the new RS in step 523.

To notify the addition of the new upper RS in the data delivery route and the connection between the RS and the new upper RS, the Route change notice message contains the following information.

TABLE 7

| Syntax | Notes |
|---|---|
| Route change notice message format( ) | |
| { | |
| RS ID | New lower RS ID |
| Entry information | Information for network entry |
| | with the new RS |
| } | |

In Table 7, the Route change notice message includes RS ID identifying the RS that will connect to the new upper RS and Entry information that provides information necessary for network reentry with the RS. The network reentry information may include information required for fast network reentry between the RS and the new upper RS and fast reconfiguration of a new data delivery route via the RS and the new upper RS. The Route change notice message may further include information about data exchanged with the MS during a time period from release of the old data delivery route to reconfiguration of the new data delivery route. The Route change notice message includes information about the RS, lower MS(s) of the RS and lower RS(s) of the RS. The information is, for example, Connection IDs (CIDs) or tunnel IDs. The BS can provide the new upper RS with a frame number corresponding to the start time of the network reentry with the RS and this frame number is identical to that included in the Route change request message. If the RS is supposed to send a non-contention-based ranging message to the new upper RS, the BS may provide the RS with information about a UL area in which the RS can send the non-contention-based ranging message.

Based on the information included in the Route change notice message, the new upper RS is aware that it will form a new data delivery route with the MS. Network reentry with the RS is required to form the new data delivery route while acquiring the information about data to be sent/received to/from the MS via the new data delivery route, and the CIDs or tunnel IDs of the RS and the MSs under the new upper RS. When the RS is supposed to send a non-contention-based ranging message to the new upper RS, the new upper RS can acquire necessary UL area information.

Meanwhile, if it is determined that it is impossible to reconfigure the data delivery route among RSs managed by the BS in step 517, the BS determines that a compulsory handover to another BS is required for the MS and sends a Route change request message commanding a compulsory MS handover. As shown in step 525, a request message to the RS is configured as illustrated in Table 5. Or if a handover is needed for the MS, the BS sends a MOB_BSHO-REQ message to trigger the handover.

If it is determined that there is no need for reconfiguring the data delivery route including the RS to the MS in step 515, the BS continues with the general communication operation with the RS in step 527 and then ends the process of the present invention.

On the other hand, if there is a need for reconfiguring the data delivery route, the BS can send a system configuration information message with system configuration information about a changed frame structure resulting from the route reconfiguration to lower RS(s) of the RS, if the RS has lower RS(s).

Meanwhile, from the Route change request message of Table 5 and the Route change ACK message of Table 6, the old upper RS of the RS can be aware that it will not be included any longer in the data delivery route to the lower MS of the RS.

The BS can command the old upper RS to delete information about the RS and the lower node managed by the RS by sending a message notifying the change of the data delivery route running to the lower node via the RS. Thus, the old upper RS deletes the information about the RS and the RS's lower node, recognizing the route change by the received message. The old upper RS can be any of upper nodes between the BS and the RS, including the direct upper node of the RS.

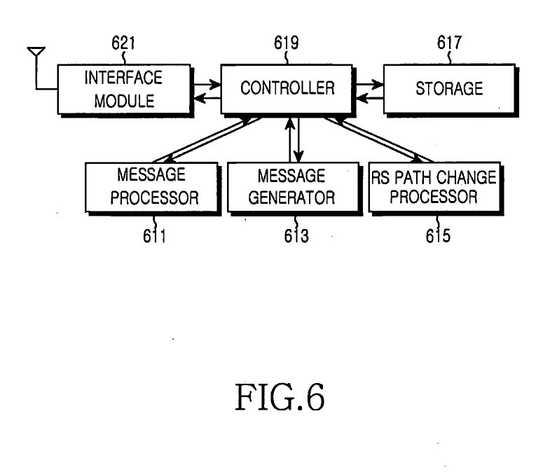

FIG. 6 is a block diagram of the BS (or the RS) according to the present invention. The BS and the RS have the same interface module (communication module) and the same configuration. Therefore, operations of the BS and the RS will be described, taking a single apparatus illustrated in FIG. 6.

Regarding the configuration of the RS, a controller 619 provides overall control to the RS. For instance, controller 619 processes and controls voice calls and data communications. In addition to the typical functionalities, controller 619 performs an operation for changing a data delivery route according to the present invention. Controller 619 provides a message received from an MS or a BS to a message processor 611 and a transmission message for the MS or the BS received from message processor 613 to an interface module 621.

Message processor 611 analyzes a message received from the MS or the BS and notifies controller 619 of the analysis result. According to the present invention, message processor 611 extracts control information from the received message upon receipt of a Neighbor notification message including neighboring node information illustrated in Table 1, Route change request message requesting an upper node change illustrated in Table 5, Route change notice message indicating that the RS is selected as a new upper RS in a data delivery route, illustrated in Table 7, message including a scanning level threshold illustrated in Table 2, or a message including a report level threshold illustrated in Table 4. Controller 619 performs an operation according to the control information received from message processor 611.

Under the control of controller 619, message generator 613 generates a message to be sent to an MS managed by the RS and provides the message to controller 619. According to the present invention, message generator 613 generates an RS signal quality report message reporting the signal level measurements of neighbor nodes, illustrated in Table 3, or a Route ack message illustrated in Table 6 in response to a received route change request and provides the message to interface module 621 through controller 619.

An RS path change processor 615 measures the signal levels of neighboring nodes upon request from the BS or autonomously and performs the necessary function to report neighboring nodes having signal levels equal to or larger than a report level threshold to the BS, when needed. Also, RS path change processor 615 performs a function for processing a route change request or an MS compulsory handover request from the BS.

A storage 617 stores programs for controlling the overall operation of the RS and temporary data generated during execution of the programs. That is, storage 617 stores data and control information to be sent to the MS or the BS.

Interface module 621 is a module for communicating with the MS or the BS, including a Radio Frequency (RF) processor and a baseband processor. The RF processor downconverts an RF signal received through an antenna to a baseband signal and provides the baseband signal to the baseband processor. The RF processor also upconverts a baseband signal received from the baseband processor to an RF signal transmittable in the air and sends the RF signal through the antenna. For example, in BWA, the baseband processor Fast Fourier Transform (FFT) processes a signal received from the RF processor, channel-decodes the FFT signal, and provides the resulting original information data (traffic or a control message) to controller 619. In the reverse order of the above operation, the baseband processor processes information data received from controller 619 by channel encoding and Inverse Fast Fourier Transform (IFFT) and provides the IFFT signal to the RF processor.

Regarding the configuration of the BS, controller 619 provides overall control to the BS. For instance, controller 619 processes and controls voice calls and data communications. In addition to the typical functionalities, controller 619 performs an operation for changing a data delivery route according to the present invention. Controller 619 provides a message received from an MS or an RS to a message processor 611 and a transmission message for the MS or the RS received from message processor 613 to interface module 621.

Message processor 611 analyzes a message received from the MS or the RS and notifies controller 619 of the analysis result. According to the present invention, upon receipt of an TS signal quality report message reporting the signal levels of neighboring nodes illustrated in Table 3 or a Route change ack message acknowledging an upper node change request illustrated in Table 6, message processor 611 extracts control information from the received message. Controller 619 performs an operation according to the control information received from message processor 611.

Under the control of controller 619, message generator 613 generates a message to be sent to the MS or the RS and provides the message to controller 619. According to the present invention, message generator 613 generates a Neighbor notification message and provides the message to the interface module 621 through the controller 619. The message includes neighboring node information illustrated in Table 1, a Route change request message requesting an upper node change illustrated in Table 5, a Route change notice message indicating that the RS is selected as a new upper RS in a data delivery route, illustrated in Table 7, a message including a scanning level threshold illustrated in Table 2, or a message including a report level threshold illustrated in Table 4.

RS path change processor 615 configures neighboring node information to be sent to the RS and determines the report level threshold required for the RS to measure the signal levels of neighboring nodes and report them. It also selects an upper RS suitable for forming a new data delivery route based on the reported signal level measurements of the neighboring nodes and performs the necessary function to send a route change request or a compulsory MS handover request to the RS.

Storage 617 stores programs for controlling the overall operation of the BS and temporary data generated during execution of the programs. That is, storage 617 stores data and control information to be sent to the MS or the RS.

Interface module 621 is a module for communicating with the MS or the RS, including an RF processor and a baseband processor. The RF processor downconverts an RF signal received through an antenna to a baseband signal and provides the baseband signal to the baseband processor. The RF processor also upconverts the baseband signal received from the baseband processor to an RF signal and sends the RF signal through the antenna. For example, in BWA, the baseband processor processes a signal received from the RF processor, channel-decodes the FFT signal, and provides the resulting original information data (traffic or a control message) to controller 619. In the reverse order of the above operation, the baseband processor processes information data received from controller 619 by channel encoding and IFFT and provides the IFFT signal to the RF processor.

In the above-described RS or BS configuration, controller 619 controls message processor 611, message generator 613, and RS path change processor 615. That is, controller 619 can perform the functions of message processor 611, message generator 613, and RS path change processor 615.

While it has been described that upon receipt of a scanning report from an RS, a BS decides as to whether a data delivery route needs to be changed based on the scanning report, it can be further contemplated that the BS determines that an upper RS of the RS is not capable of providing any more relay service in a data delivery route to an MS due to a system problem and thus commands the RS to perform and report scanning.

That is, if the channel status of the upper RS is below a predetermined threshold, the BS determines that the data delivery route needs to be reconfigured and requests the RS to scan neighboring nodes and report the scanning results. Upon receipt of the scanning results, the BS determines if the data delivery route can be reconfigured among RSs managed by the BS in step 517.

As described above, the present invention provides an apparatus and method for reconfiguring the data delivery route by replacing the RS with another RS managed by a BS, when an RS among RSs forming a data delivery route to an MS is not capable of relaying any more data due to system defects or poor channel status in a multi-hop relay BWA communication system. As the defect of the data delivery route is eliminated, communication service can be provided seamlessly to the MS.

While the invention has been shown and described with reference to certain preferred embodiments thereof, it will be understood by those skilled in the art that various changes in form and details may be made therein without departing from the spirit and scope of the invention as further defined by the appended claims.

What is claimed is:

1. A method for changing a data delivery route in a Relay Station (RS) in a wireless communication system, comprising:
scanning neighboring nodes and an upper node and transmitting a scanning result report message to a Base Station (BS); and
connecting to a new upper node, upon receipt of a node change request message from the BS, the node change request message requesting the RS to change from the upper node to the new upper node.

2. The method of claim 1, further comprising transmitting a node change acknowledgement (ACK) message to the BS, upon receipt of the node change request message from the BS.

3. The method of claim 1, wherein the node change request message includes at least one of a type indicating that the node change request message requests a node change;
an RS Identifier (ID) identifying the RS to receive the node change request message and change the upper node to the new upper node;
a new upper node ID of the RS;
system configuration information required for the RS to continue relaying to lower nodes managed by the RS after changing the upper node to the new upper node;
a frame number corresponding to a time when the RS performs network reentry with the new upper node;
relay zone information indicating a relay zone in which the new upper node sends a downlink MAP;
information needed for the network reentry with the new upper node;
and an uplink area information indicating an uplink area in which the RS sends a non-contention-based ranging message to the new upper node.

4. The method of claim 2, wherein the node change ACK message includes at least one of an RS ID identifying the RS that has received the node change request message, an ID of the new upper node of the RS, and information about data transmission to MS processed so far by the RS.

5. The method of claim 1, further comprising performing a compulsory handover procedure with Mobile Station (MS), upon receipt of a compulsory MS handover request message from the BS.

6. The method of claim 5, wherein the compulsory MS handover request message includes at least one of a type indicating that the compulsory MS handover request message requests a compulsory MS handover;
an RS ID identifying the RS to receive the compulsory MS handover request message and change the upper node to the new upper node;

7. The method of claim 1, further comprising:
receiving from a serving BS a message indicating a handover of MS managed by the RS and commanding the RS to delete information about the MS; and
determining from the received message that the MS performs the handover and deleting the information about the MS.

8. The method of claim 1, wherein the scanning step comprises scanning the neighboring nodes and the upper node, when a channel measurement of the upper node is less than or equal to a predetermined threshold.

9. The method of claim 1, wherein the scanning step further comprises scanning the neighboring nodes and the upper node, upon receipt of a scanning request message from the BS.

10. The method of claim 1, further comprising receiving a message including neighboring node information from the BS.

11. The method of claim 10, wherein the message including neighboring node information includes at least one of the number of BSs;
a BS ID identifying each of the BSs;
support node information indicating a mode supported by the each BS;
the number of RSs, RS ID identifying each of the RSs, amble information about neighbor nodes, and system configuration information related to frame structures of the neighbor nodes.

12. The method of claim 1, wherein the scanning result report message includes at least one of the number of nodes reported to the BS, IDs of the nodes, and signal level measurements of the nodes.

13. The method of claim 12, wherein the nodes reported to the BS have signal levels greater than or equal to a predetermined threshold.

14. A method for changing a data delivery route in a Base Station (BS) in a wireless communication system, comprising:
determining if a data delivery route needs to be changed, upon receipt of a scanning result report message reporting scanning results of neighboring nodes and an upper node of a Relay Station (RS) from the RS; and
determining an upper node for the RS, to form a new data delivery route, when determining that the data delivery route needs to be changed, and transmitting to the RS a node change request message requesting the RS to change from the upper node to the new upper node.

15. The method of claim 14, wherein the transmission comprises:
determining if the data delivery route can be changed by changing the path between RSs managed by the BS, when determining that the data delivery route needs to be changed; and
determining the upper node to form the new data delivery route, when determining that the data delivery route can be changed by changing a path between RSs managed by the BS, and transmitting the node change request message to the RS.

16. The method of claim 15, wherein the transmission further comprises transmitting a compulsory MS handover request message to the RS, when determining that the data delivery route cannot be changed by changing a path between RSs managed by the BS.

17. The method of claim 16, wherein the compulsory MS handover request message includes at least one of a type indicating that the compulsory MS handover request message requests a compulsory MS handover;
an RS ID identifying the RS to receive the compulsory MS handover request message and change the upper node to the new upper node;

18. The method of claim 15, further comprising transmitting to the RS a message indicating a handover of MS managed by the RS and commanding the RS to delete information about the MS, when determining that the data delivery route cannot be changed by changing a path between RSs managed by the BS.

19. The method of claim 14, further comprising transmitting a data delivery route change notice message to the new upper node, upon receipt of a node change acknowledgement (ACK) message from the RS.

20. The method of claim 14, wherein the node change request message includes at least one of a type indicating that the node change request message requests a node change;
an RS ID identifying the RS to receive the node change request message and change the upper node to the new upper node;
a new upper node ID of the RS;
system configuration information required for the RS to continue relaying to lower nodes managed by the RS after changing the upper node to the new upper node;
a frame number corresponding to a time when the RS performs network reentry with the new upper node;
relay zone information indicating a relay zone in which the new upper node sends a downlink MAP;
information needed for the network reentry with the new upper node; and
an uplink area information indicating an uplink area in which the RS sends a non-contention-based ranging message to the new upper node.

21. The method of claim 19, wherein the node change ACK message includes at least one of an RS ID identifying the RS that has received the node change request message;
an ID of the new upper node of the RS; and
information about data transmission to MS processed so far by the RS.

22. The method of claim 14, further comprising transmitting a message including neighboring node information to the RS.

23. The method of claim 22, wherein the message including neighboring node information includes at least one of the number of BSs;
a BS ID identifying each of the BSs;
support node information indicating a mode supported by the each BS;
the number of RSs, RS ID identifying each of the RSs;
amble information about neighbor nodes; and
system configuration information related to frame structures of the neighboring nodes.

24. The method of claim 14, wherein the scanning result report message includes at least one of the number of nodes reported to the BS, IDs of the nodes, and signal level measurements of the nodes.

25. The method of claim 24, wherein the nodes reported to the BS have signal levels greater than or equal to a predetermined threshold.

26. The method of claim 14, further comprising transmitting to the RS a scanning request message commanding the RS to scan the neighboring nodes and the upper node of the RS.

27. The method of claim 26, further comprising:
receiving amble information from the neighboring nodes and the upper node of the RS; and
generating the scanning request message including the amble information.

28. The method of claim 14, further comprising transmitting to the new upper node of the RS a node change notice message indicating connection of the RS to the new upper node.

29. The method of claim 28, wherein the node change notice message includes at least one of an RS ID identifying the RS to connect to the new upper node;
entry information required for network reentry with the RS, when the RS connects to the new upper node;
information about data transmitted and received to and from MS until the new data delivery route is configured after releasing the data delivery path;
information about the RS and lower MS(s) and lower RS(s) of the RS;
a frame number indicating a start time of the network reentry; and
uplink area information indicating an uplink area in which the RS can transmit a non-contention-based ranging message to the new upper node.

30. The method of claim 14, further comprising:
transmitting to the lower RS a system configuration information message including information about a frame structure changed due to the node change if the RS has lower RS(s).

31. The method of claim 14, further comprising:
transmitting to each of current upper nodes of the RS a message indicating the change of a data delivery route involving the RS and lower nodes of the RS and commanding the each upper node to delete information about the RS and the lower nodes of the RS.

32. An apparatus for changing a path between Relay Stations (RSs) in a wireless communication system, comprising:
an RS for scanning neighboring nodes and an upper node, transmitting a scanning result report message to a Base Station (BS), and connecting to a new upper node, upon receipt of a node change request message from the BS, the node change request message requesting the RS to change from the upper node to the new upper node; and
the BS for determining if a data delivery route needs to be changed, upon receipt of the scanning result report message from the RS, determining the new upper node for the RS, to form a new data delivery route, when determining that the data delivery route needs to be changed, and transmitting the node change request message to the RS.

33. The apparatus of claim 32, wherein the BS transmits neighboring node information to the RS.

34. The apparatus of claim 32, wherein when the BS determines that the data delivery route needs to be changed and the data delivery route cannot be changed by changing a path between RSs managed by the BS, the BS requests a compulsory Mobile Station (MS) handover to the RS, and the RS performs a compulsory MS handover with MS upon receipt of the compulsory MS handover request.

35. The apparatus of claim 32, wherein the BS transmits a data route delivery change notice message to the new upper node.

36. A method for changing a data delivery route in a Base Station (BS) in a wireless communication system, comprising:
determining whether the data delivery route needs to be changed, if a channel status of a Relay Station (RS) is less than or equal to a predetermined threshold;
requesting the lower RS of the RS to scan neighboring nodes and report scanning results to the BS, when determining that the data delivery route needs to be changed; and
determining a new upper node for the lower RS, for configuring a new data delivery route, upon receipt of the scanning results from the lower RS, and requesting the lower RS to change from the upper node to the new upper node.

37. The method of claim 36, wherein the node change requesting comprises:
determining whether a path between RSs managed by the BS can be changed, upon receipt of the scanning results from the lower RS; and
determining the new upper node for the lower RS and requesting the lower RS to change from the upper node to the new upper node, when determining that a path between RSs managed by the BS can be changed.

38. The method of claim 37, further comprising transmitting a compulsory Mobile Station (MS) handover request to the lower RS, when determining that a path between RSs managed by the BS cannot be changed.

39. The method of claim 36, further comprising transmitting a data delivery route change notice message to the new upper node, upon receipt of a node change acknowledgement (ACK) message from the lower RS.

40. The method of claim 36, further comprising transmitting neighboring node information to the RS.

41. An apparatus for changing a path between Relay Stations (RSs) in a wireless communication system, comprising:
a Base Station (BS) for
determining that a data delivery route needs to be changed, if a channel status of an RS is less than or equal to a predetermined threshold;
transmitting a scanning request message to a lower RS of the RS, the scanning request message requesting the lower RS to scan neighboring nodes and report scanning results to the BS;
determining a new upper node for the lower RS, for configuring a new data delivery route, upon receipt of the scanning results from the lower RS;
transmitting a node change request message to the lower RS, the node change request message requesting the lower RS to change from the upper node to the new upper node; and
the lower RS for scanning the neighboring nodes, upon receipt of the scanning request message from the BS, and connecting to the new upper node, upon receipt of the node change request message from the BS.

42. The apparatus of claim 41, wherein the BS transmits neighboring node information to the lower RS.

43. The apparatus of claim 41, wherein when the BS determines that the data delivery route needs to be changed and the data delivery route cannot be changed by changing a path between RSs managed by the BS, the BS requests a compulsory Mobile Station (MS) handover to the RS, and the RS performs a compulsory MS handover with MS upon receipt of the compulsory MS handover request.

44. The apparatus of claim 41, wherein the BS transmits a data route delivery change notice message to the new upper node.
